(19) United States
(12) Patent Application Publication
(10) Pub. No.: US 2026/0010443 A1
(43) Pub. Date: Jan. 8, 2026

(54) DISTRIBUTED STORAGE SYSTEM AND DATA SHARING METHOD

(71) Applicant: Hitachi Vantara, Ltd., Yokohama-shi (JP)

(72) Inventors: Toshiyuki ARITSUKA, Tokyo (JP); Yoshinori OHIRA, Tokyo (JP); Takahiro YAMAMOTO, Tokyo (JP)

(73) Assignee: Hitachi Vantara, Ltd., Yokohama-shi (JP)

(21) Appl. No.: 19/072,857

(22) Filed: Mar. 6, 2025

(30) Foreign Application Priority Data
Jul. 3, 2024 (JP) 2024-107641

(51) Int. Cl. G06F 11/16

(52) U.S. Cl. CPC G06F 11/1662; G06F 11/1612

(57) ABSTRACT

When rebuilding a data block and a second redundant code identical in content with a data block and a second redundant code stored in a storage device of one or more of nodes, on a different node, based on a first redundant code, a controller rebuilds the data block and second redundant code on a node different from a substitute node substituting for a node storing a data block or second redundant code to be rebuilt, transfers the rebuilt data block and second redundant code to the substitute node, and stores them in the storage device of the substitute node.

### BACKGROUND OF THE INVENTION

### 1. Field of the Invention

The present invention relates to a distributed storage system and a data sharing method, and is preferably applied to, for example, a distributed storage system related to a technology of making data redundant and storing redundant data.

### 2. Description of the Related Art

To analyzing and utilizing enormous data created in social life and corporate activities, a storage system that stores these data is essential. Given that data stored in such a system is important, loss of such data or inability to timely access necessary data due to a hardware failure, network failure, etc., would have a great impact on social life and corporate activities, leading to difficulty in maintaining normal social life or lose of business opportunities. To prevent such a situation, data may be made redundant to prevent lose of data when a node or device develops a fault. This is done for the purpose of minimizing the influence of a fault related to the storage system and improving its availability. What is important for enhancing the availability of the storage system is to quickly recover data redundancy after the occurrence of a fault and put the storage system back to its sound condition.

Methods of making data redundant include, for example, mirroring by which copies of data are prepared, and erasure coding by which a redundant code used for redundancy processing is created from data. A distributed storage system including a plurality of nodes may adopt the erasure coding for the reason that at execution of redundancy processing, it saves a more disk space than the mirroring does. According to the erasure coding, when a node or a device like a disk has developed a fault, data stored in the fault-developing device and no longer accessible is reconstructed from data and a redundant code that are stored distributively in a different device, the reconstructed data is stored in a given node, and then redundancy processing is executed again to recover system availability (which will hereinafter be referred to also as “rebuilding”). The erasure coding involves a method of allowing efficient access to data distributively stored in a plurality of nodes. Such a method is disclosed as, for example, a method of enhancing data locality and optimizing a network path through which an application or the like access a storage (see, for example, Japanese Patent No. 6815378, Japanese Patent No. 6798007, and Japanese Patent No. 6547057).
Patent Literature 1: Japanese Patent No. 6815378
Patent Literature 2: Japanese Patent No. 6798007
Patent Literature 3: Japanese Patent No. 6547057

### SUMMARY OF THE INVENTION

According to the method disclosed in Japanese Patent No. 6815378 or Japanese Patent No. 6798007, to rebuild data that is lost or rendered inaccessible due to a device fault or the like, data necessary for rebuilding is collected in a node having a recovery device and serving as a rebuilding destination (hereinafter, “substitute node”). Data necessary for rebuilding is collected from a different node through an internode communication path. Where the bandwidth performance of the internode communication path is low, therefore, a time to take to collect data necessary for rebuilding gets longer, which significantly affects rebuilding performance. According to the method disclosed in Japanese Patent No. 6815378 or Japanese Patent No. 6798007, when a redundant code stored in a fault-developing device and no longer accessible is rebuilt at the substitute node, all data necessary for rebuilding is transferred to the substitute node through the internode communication path. As a result, the substitute node takes much time to collect necessary data. In addition, a processing load resulting from rebuilding concentrates at the substitute node, which poses a problem that the I/O performance of the substitute node is affected by the processing load resulting from rebuilding. Furthermore, according to the method disclosed in Japanese Patent No. 6798007, rebuilding is executed distributively at a plurality of non-fault-developing nodes operating in a distributed storage system. However, when rebuilding is executed at a specific non-fault-developing node undergoing a high processing load resulting from input/output from/to a host server, rebuilding execution efficiency drops, which is another problem.

The present invention has been conceived in view of the above problems, and it is therefore an object of the present invention to provide a distributed storage system and a data sharing method that when a fault occurs, can shorten a time required for rebuilding data and/or a redundant code of the data.

In order to solve the above problems, the present invention provides a distributed storage system comprising a plurality of nodes each including a storage device that stores data and a controller that makes data redundant, the data being stored in the storage device. The controller divides data on a received writing request into a plurality of data blocks and writes the data blocks to the storage device, and generates a first redundant code from the data blocks and transmits the data blocks and the first redundant code to a different node. A controller of the different node generates a second redundant code, from a plurality of data blocks received from the nodes and the first redundant code, and stores the second redundant code in the storage device. A data block and a second redundant code that are stored in the storage device of a node are rebuilt at a different node, and a substitute node having rebuilt the data block stores the data block reconstructed in the storage device and processes a reading request and a writing request from a host server. When rebuilding the data block and the second redundant code, one of the nodes reconstructs a data block involved in the rebuilding, based on the data block and the second redundant code that are stored in one of the nodes, generates a first redundant code, based on the data blocks stored in one of the nodes, reconstructs a second redundant code involved in the rebuilding, based on the first redundant code generated and on the data blocks stored in one of the nodes, and stores the data block and the second redundant code have been reconstructed and being involved in the rebuilding, in the storage device. A node that reconstructs the second redundant code is a specific node different from the substitute node in which the data block reconstructed is stored.

The present invention provides a data sharing method for a distributed storage system comprising a plurality of nodes each including a storage device that stores data and a controller that makes data redundant, the data being stored in the storage device. The data sharing method comprises: causing the controller to divide data on a received writing request into a plurality of data blocks and write the data blocks to the storage device and to generate a first redundant code from the data blocks and transmit the data blocks and the first redundant code to a different node; causing a controller of the different node to generate a second redundant code from a plurality of data blocks received from the nodes and store the second redundant code in the storage device; causing the controller to rebuild a data block and a second redundant code on a different node, the data block and the second redundant code being identical in content with a data block and a second redundant code that are stored in the storage device of a node; causing a substitute node having rebuilt the data block to store the data block reconstructed in the storage device and process a reading request and a writing request from a host server; when rebuilding the data block and the second redundant code, causing one of the nodes to reconstruct a data block involved in the rebuilding, based on the data block and the second redundant code that are stored in one of the nodes, to generate a first redundant code, based on the data blocks stored in one of the nodes, and to reconstruct a second redundant code involved in the rebuilding, based on the first redundant code generated and on the data blocks stored in one of the nodes, and to store the data block and the second redundant code have been reconstructed and being involved in the rebuilding, in the storage device; and selecting a node that reconstructs the second redundant code, as a specific node different from the substitute node in which the data block reconstructed is stored.

According to the present invention, when a fault occurs, a time to take to rebuild data and/or a redundant code of the data can be shortened.

### BRIEF DESCRIPTION OF THE DRAWINGS

FIG. 1 depicts a configuration example of a distributed storage system according to an embodiment;

FIG. 2 depicts a configuration example of a storage control program according to this embodiment;

FIG. 3 depicts an example of a two-stage redundancy processing method according to this embodiment;

FIG. 4 depicts a relationship between data, data blocks, and class 1 redundant codes according to this embodiment;

FIG. 5 depicts a relationship between data blocks, class 1 redundant codes, and class 2 redundant codes according to this embodiment;

FIG. 6 depicts a first example of a method of rebuilding a data block according to this embodiment;

FIG. 7 depicts a first example of a method of rebuilding a different data block according to this embodiment;

FIG. 8 depicts a first example of a method of rebuilding a class 2 redundant code according to this embodiment;

FIG. 9 depicts a second example of the method of rebuilding the class 2 redundant code according to this embodiment;

FIG. 10 depicts a second example of the method of rebuilding the data block according to this embodiment;

FIG. 11 depicts a second example of the method of rebuilding the different data block according to this embodiment;

FIG. 12 depicts a third example of the method of rebuilding the class 2 redundant code according to this embodiment;

FIG. 13 depicts a procedure of selecting a rebuilding destination node according to this embodiment, based on a loaded state of a node;

FIG. 14 depicts a fourth example of the method of rebuilding the class 2 redundant code according to this embodiment;

FIG. 15 depicts an example of a rebuilding-executing node selection process; and

FIG. 16 depicts an example in which a rebuilt class 2 redundant code is not transferred to a substitute node.

### DESCRIPTION OF THE PREFERRED EMBODIMENT

In the following description, an “interface device” refers to at least one interface device. At least one interface device is at least one of the following interface devices.
At least one I/O (input/output) interface device An I/O interface device is an interface device for at least one of an I/O device and a display computer in a remote location. The I/O interface device for the display computer may be a communication interface device. At least one I/O device may be a user interface device, which is, for example, either an input device, such as a keyboard and a pointing device, or an output device, such as a display device.
At least one communication interface device At least one communication interface device is either one or more communication interface devices of the same type (e.g., one or more network interface cards (NIC)) or two or more communication interface devices of different types (e.g., a network interface card and a host bus adapter (HBA)).

In the following description, a “memory” refers to at least one memory device, which is, for example, at least one storage device, and typically refers to a main storage device. At least one memory device making up a memory is a volatile memory device or a nonvolatile memory device.

In the following description, a “permanent storage device” refers to at least one permanent storage device, which is, for example, at least one storage device. The permanent storage device is typically a nonvolatile storage device (e.g., an auxiliary storage device). Specifically, for example, it is a hard disk drive (HDD), a solid state drive (SSD), a nonvolatile memory express (NVMe) drive, or a storage class memory (SCM). In the following description, a “storage device” refers to at least a memory among a memory and a permanent storage device.

In the following description, a “processor” refers to at least one processor device. At least one processor device is typically a microprocessor device, such as a central processing unit (CPU), but may be a different type of processor device, such as a graphics processing unit (GPU). At least one processor device has a single core or multiple cores. At least one processor device may refer to a processor core. At least one processor device may refer to a processor device defined in a broader sense, such as a circuit composed of a group of gate arrays that are run by a hardware description language to execute a part or the whole of a process, such as a field-programmable gate array (FPGA), a complex programmable logic device (CPLD), or an application specific integrated circuit (ASIC), or a dedicated hardware circuit.

In the following description, information showing input and output obtained in response to input may be expressed in a table and explained in the form of a “xxx table”. Such information may be data of any structure (e.g., structural data or non-structural data.) and may be a neural network, which produces output in response to input, or a learning model typically known as a genetic algorithm, a random forest tree, etc. The “xxx table”, therefore, can be referred to as “xxx information”. In the following description, a configuration of each table is shown exemplarily. One table may be divided into two or more tables, or the whole or a part of two or more tables may be integrated into one table.

In the following description, a function may be described in an expression “yyy unit”. The function, however, may be implemented by a processor that executes one or more computer programs, or by one or more hardware circuits (e.g., FPGA or ASIC), or by a combination of the processor and the hardware circuits. When the function is implemented by the processor's executing the program, a prescribed process is carried out, using a storage device and/or an interface device on a necessary basis. In such a case, therefore, the function may be considered to be at least a part of the processor. A process explained in terms of function may be considered to be a process carried out by a processor or by a device including the processor. A program may be acquired from a program source and installed. The program source may be, for example, a program distribution server or a computer-readable recording medium (e.g., a non-transitory recording medium). Each function is described as an example. A plurality of functions may be integrated into a single function or a single function may be divided into a plurality of functions.

In the following description, when elements of the same type are described collectively as elements not distinguished from each other, common parts of reference numerals are used to collectively refer to the elements. When elements of the same type are described as elements distinguished from each other, however, the reference numerals may be used to separately refer to individual elements.

Embodiments of the present invention will hereinafter be described with reference to the drawings. The following description and drawings are examples for describing the present invention, and are omitted and simplified, when necessary, to make the description clear. The present invention can be implemented in other various forms, and, unless otherwise specified, each constituent element is allowed to take a singular form and a plural form as well.

Embodiments described below do not limit the invention disclosed in the claims, and all combinations of constituent elements described in the embodiments are not necessarily essential to solutions provided by the invention.

Hereinafter, a distributed storage system according to an embodiment of the present invention will be described.

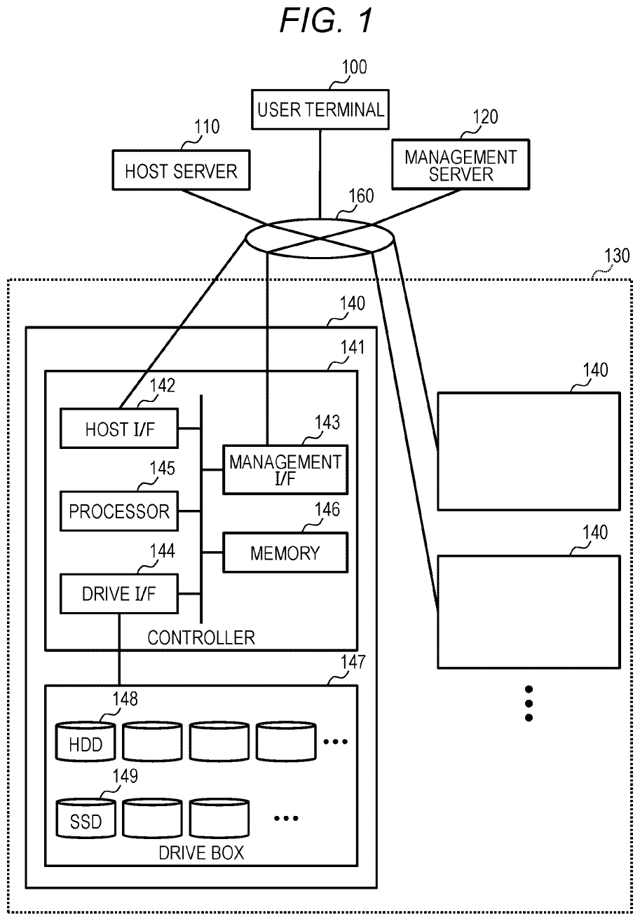

FIG. 1 depicts a configuration example of a computer system according to this embodiment.

The computer system includes a user terminal 100, a host server 110, a management server 120, and a distributed storage system 130. These components can communicate with each other via a network 160. The distributed storage system 130 has a distributed configuration composed of a plurality of storage nodes 140. The host server 110, the management server 120, and the storage nodes 140 are each composed of a physical computer (bare machine), but may each be compose of a virtual machine (VM) or container virtually configured on a physical computer or a cloud system. For simpler illustration, FIG. 1 shows three storage nodes only. The number of storage nodes making up the distributed storage system is, however, not limited to a specific number, and therefore a storage node may be added to or removed from the system when necessary. In this embodiment, the storage node may be abbreviated as a node. The distributed storage system can be configured using an existing technology. Each of these constituent elements is provided as any given number of constituent elements. The user terminal 100 may include the function of the host server 110 and/or the function of the management server 120.

The network 160 may be, for example, a local area network (LAN) or a storage area network (SAN). The host server 110 and the management server 120 may access the distributed storage system 130 via different networks, respectively, and the user terminal 100 may access the host server 110 or the management server 120 via a network different from the network 160.

The host server 110, the management server 120, the distributed storage system 130, and the storage nodes 140 making up the distributed storage system may be arranged in the same site, or some or all of them may be arranged respectively in different sites, or some or all of them may be arranged on a cloud system. In such a case, different sites and/or a site and a cloud system may be interconnected via, for example, a wide area network (WAN).

The user terminal 100 is a device that allows a user to access the computer system. The user terminal 100 is allowed to have, for example, a general computer configuration, and includes, for example, an interface device, a storage device, and a processor connected thereto. The user terminal 100 may include hardware dedicated to specific processing. The user terminal 100 may have an I/O device (e.g., a keyboard, a pointing device, a display device, etc.).

The host server 110 is a host machine that runs a user application or the like. The host server 110 is allowed to have, for example, a general computer configuration, and includes an interface device, a storage device, and a processor connected thereto. The host server 110 may include hardware dedicated to specific processing. The host server 110, which can execute various software programs, executes, for example, a database program and a Web service, and writes and/or reads data created by the database program and the Web service to/from the distributed storage system 130 via the network 160.

The management server 120 manages the distributed storage system 130. The management server 120 is allowed to have, for example, a general computer configuration, and includes an interface device, a storage device, and a processor connected thereto. The management server 120 may include hardware dedicated to specific processing.

The storage system according to this embodiment is the distributed storage system that includes the storage nodes 140 each including storage devices (equivalent to solid state drives (SSD) 149 and hard disk drives (HDD) 148, which will to be described later) that stores data and a controller that makes data redundant, the data being stored in the storage devices. The distributed storage system distributively manages each piece of data composed of a plurality of data blocks by distributing the data blocks respectively to the storage nodes 140, receives an input/output request for data reading/data writing from/to the host server and a writing data, and provides read data to the host server.

Each storage node 140 is allowed to have, for example, a general computer configuration, and includes an interface device, a storage device, and a processor connected thereto. The storage node 140 may include hardware dedicated to specific processing. The storage node 140 includes a controller 141 and a drive box 147. The controller 141 includes a host interface 142, a management interface 133, a drive interface 144, a memory 146, and a processor 145 connected to these components. Each of these constituent elements is provided as any given number of constituent elements.

The host interface 142 is an interface device for communication with the host server 110. The management interface 143 is an interface device for communication with the management server 120. The drive interface 144 is an interface device for communication with the drive box 147.

The drive box 147 accommodates one or more nonvolatile or volatile storage drives that store various data used by an application program of the host server 110. The drive box 147 is connected to the drive interface 144 of the controller 141.

In the configuration example of FIG. 1, the drive box 147 includes at least either a plurality of hard disk drives (HDD) 148 and a plurality of solid state drives (SSD) 149. The drives 148 and 149 may form a group for data redundancy, such as a redundant array of independent disks (RAID).

The controller 141 controls the distributed storage system 130. The controller 141 provides the host server 110 with a logical volume for storing data read/written by the host server 110. The controller 141 allocates a physical storage area of the drives 148 and149 to the volume, and stores data in the drive 148 and 149. The controller 141 thus gives the host server 110 a storage function. The controller 141 has a function of controlling cooperative operation between storage nodes so that the distributed storage system 130 functions as a storage system.

In response to a reading request or a writing request from the host server 110, the processor 145 issues a transfer instruction or a change instruction to transfer or change data stored in the drive box 147 that corresponds to the request. The memory 146 of the controller 141 is composed of, for example, a semiconductor memory, such as a synchronous dynamic random access memory (SDRAM). The memory may be composed of a combination of a volatile memory and a nonvolatile memory.

The processor 145 executes a process for controlling the distributed storage system 130 and communicating with the host server 110, the management server 120, and the drive box 147. The memory 146, which serves as a main memory of the processor 145, stores programs and various data for control and communication. The memory 146 is used also as a disk cache (cache memory) of the controller 141. The processor 145 implements a given function by executing a program containing instruction codes, the program being stored in the memory 146.

A plurality of controllers 141 may be provided for redundancy. The controllers 141 communicate with each other via a network in the distributed storage system 130. The controllers 141 performs redundancy processing on written data, sharing of metadata, and the like via the network in the distributed storage system 130. Even if one controller 141 is blocked because of a maintenance requirement, fault, etc., another controller 141 is able to continue a storage process. The distributed storage system 130 may be configured by using a general server computer, or may include hardware dedicated to specific processing. The distributed storage system 130 can be configured by using an existing technology.

The computer system may further include a constituent element other than the constituent elements described above. For example, the network may have network equipment, such as switches and routers, connected between different areas. In addition, the computer system may be configured to connect to a storage service on a public cloud via an external network.

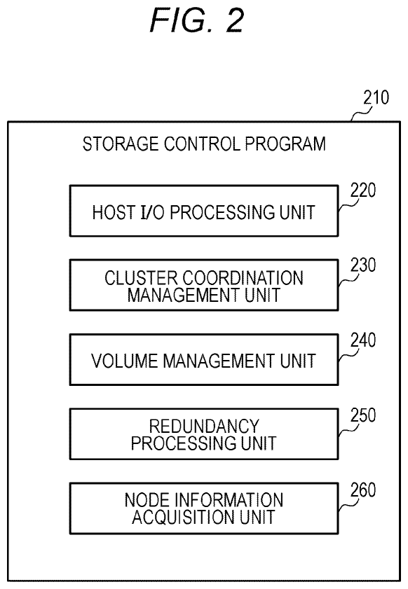

FIG. 2 shows an example of a software configuration of a storage control program 210 that is processed by the processor in the controller 141 included in the storage node 140 making up the distributed storage system 130 of FIG. 1 and that controls the distributed storage system 130. The storage control program 210 includes a host I/O processing unit 220 and a redundancy processing unit 250, and, preferably, further includes a cluster coordination management unit 230 and a volume management unit 240.

The host I/O processing unit 220 receives an I/O request for data reading or writing and writing data, from the host server 110 of FIG. 1, and processes the request or data in a format and timing executable to the storage system.

The cluster coordination management unit 230 has a function to do the following: the cluster coordination management unit 230 determines whether an I/O request from the host server, which has been processed by the host I/O processing unit 220, is a request to a volume managed by a principle storage node including the cluster coordination management unit 230 or a request to a volume managed by a different storage node, carries out control to cause the volume management unit 240 of the principle storage node to process the request when the request is made to the volume managed by the principle storage node, and, in cooperation with the cluster coordination management unit 230 of the different storage node, carries out control to cause the volume management unit 240 of the different storage node to process the request when the request is made to the volume managed by the different storage node.

When the I/O request from the host server 110 is a reading request for reading data stored in the volume managed by the principle storage node, the cluster coordination management unit 230 carries out control to cause the volume management unit 240 of the principle storage node to process the request. When the I/O request from the host server is a reading request for reading data stored in the volume managed by different storage node, the cluster coordination management unit 230, which is in cooperation with the cluster coordination management unit 230 of the different storage node, receives data transferred from the different storage node. The host I/O processing unit 220 transfers the data to read, to the host server 110.

When the I/O request from the host server 110 is a writing request to the volume managed by the principle storage node, the writing request is processed by the volume management unit 240 of the principle storage node, and writing request data is written to the volume managed by the principle storage node. When the I/O request from the host server is a writing request to the volume managed by the different storage node, writing request data is written to the volume managed by the different storage node through cooperation with the cluster coordination management unit 230 of the different storage node.

The volume management unit 240 manages a volume, reading target data from the volume, based on a reading request to the volume, and writing target data to the volume, based on a writing request to the volume.

The redundancy processing unit 250 makes data written to a volume redundant, based on a redundancy processing method, which will be described later. The redundancy processing unit 250 distributively arranges data to be made redundant and a redundant code generated by redundancy processing, in a different storage node through the cluster coordination management unit 230. The redundancy processing unit 250 may have a function of rebalancing distributively arranged data and redundant codes between storage nodes when necessary.

The redundancy processing unit 250 divides data on a received writing request into a plurality of data blocks and writes the data blocks to the storage device, and, for example, generates a first redundant code from the data blocks and transmits the data blocks and a class 1 redundant code, which is as an example of the first redundant code, to different nodes. The controller of a different storage node generates a class 2 redundant code, which is an example of a second redundant code, from a plurality of data blocks received from a plurality of storage nodes, and stores the class 2 redundant code in the storage device (hereinafter, referred to also as “drive”). The drive is, for example, at least either the HDD148 or the SSD149.

The controller of the different storage node generates the class 2 redundant code from the data blocks and class 1 redundant code received from the storage nodes, stores the class 2 redundant code in the storage device, and rebuilds the class 2 redundant code at a different storage node, the class 2 redundant code being stored in the storage device of the different storage node. A substitute node having rebuilt a data block stores the rebuilt data block in the storage device, and processes a reading request and a writing request from the host server. When rebuilding the data block and the class 2 redundant code, one of the storage nodes reconstructs a data block involved in the rebuilding, based on the data block and the class 2 redundant code stored in any one of the storage nodes, generates a class 1 redundant code, based on the data blocks stored in any one of the plurality of storage nodes, reconstructs a class 2 redundant code involved in the rebuilding, based on the generated class 1 redundant code and on a data block stored in any one of the nodes, and stores the data block and the class 2 redundant code in the storage device, the data block and the class 2 redundant code being reconstructed and involved in the rebuilding. The storage node that reconstructs the class 2 redundant code is a specific storage node different from the substitute node that stores the reconstructed data block. In this embodiment, the storage node that reconstructs the data block involved in the rebuilding, based on the data block and the class 2 redundant code, is a specific storage node different from the substitute node that stores the data block reconstructed. The class 2 redundant code reconstructed is stored in a substitute node. The storage node that stores the class 2 redundant code reconstructed is a storage node different from the substitute node that stores the data block reconstructed.

The storage control program 210 may include a node information acquisition unit 260 that acquires node information indicating states of a plurality of storage nodes. For example, the node information acquisition unit 260 acquires loaded states of the storage nodes, as the states of the storage nodes.

Specifically, using a measuring function of the operating system of the computer serving as a storage node, a known monitor program, and/or a physical sensor, the node information acquisition unit 260 acquires information on a storage node, which is one of and/or a combination of a CPU use status, a memory use status, a network bandwidth use status between storage nodes, a network bandwidth usage status between the host server and storage nodes, and a volume use status. The information on the storage node may include physical information, such as a CPU temperature, an operating frequency, a supply voltage to the computer, and a fan rotating speed. The operation of the storage control program 210 may be controlled by using these pieces of node information.

The controller obtains node information indicating a state of a node, and based on the obtained node information, selects a specific storage node that reconstructs a data block and a second redundant code. The node information includes loaded states of a plurality of nodes.

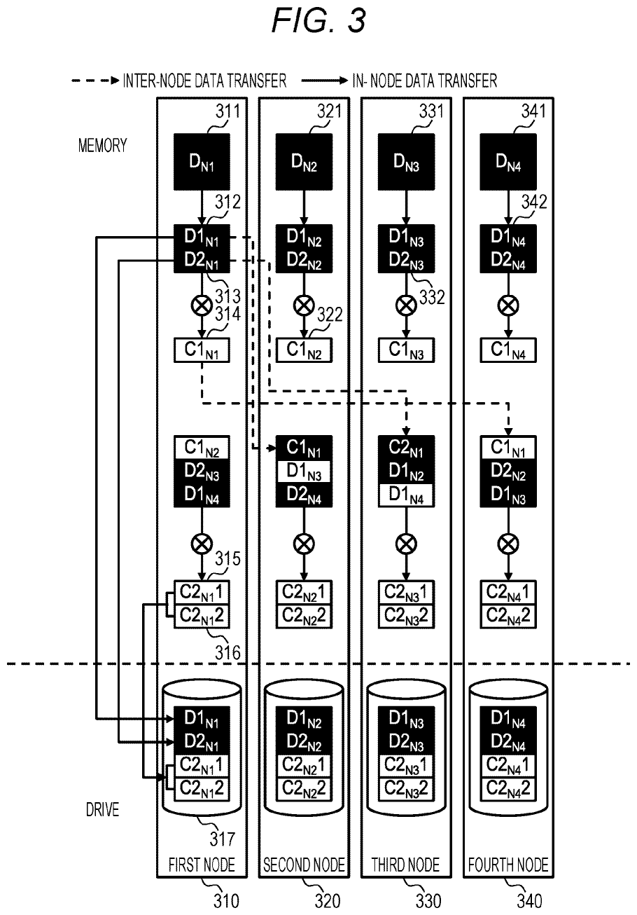

Hereinafter, for simpler description, a storage node may be simply referred to as a node. FIG. 3 shows an example in which, for example, when a fault develops in two of four nodes making up the distributed storage system, which are a first node 310, a second node 320, a third node 330, and a fourth node 340, two stages of redundancy processing allowing recovery of every data is carried out. In the example of FIG. 3, the side above a horizontal broken line is an area on a memory, and the side below the horizontal broken line is an area on a drive. In the following description including description of FIG. 3, for example, some letters and numbers that are usually expressed as subscript letters and numbers are expressed as normal letters and numbers for simpler description. According to this redundancy processing method, for example, in the case of 2D2P in which, as described later, two redundant codes are finally generated from two data blocks, only one class 1 redundant code is generated, two data blocks and one parity are distributed to a different node, and in each node, a class 2 redundant code is generated by using two data blocks and one class 1 redundant code that are collected from a different node.

In this embodiment, as the first stage of redundancy processing, the redundancy processing unit 250 generates one redundant code from two data blocks. To generate the redundant code, for example, a parity generation method or the like is used. The redundant code in the first stage is an example of a first redundant code, and is referred to as a “class 1 redundant code”. In FIG. 3, dotted arrows represent data transfer between nodes, and solid arrows represent data transfer between a memory and a drive in a node.

In FIG. 3, the above redundancy processing unit 250 first divides data DN1 311, writing of which is requested to the first node 310 by an application or the like of the host server, into two data blocks, i.e., data blocks D1N1 312 and D2N1 313 on the memory, and then generates a class 1 redundant code C1N1 314 from the data blocks D1N1 312 and D2N1 313.

Subsequently, the data blocks D1N1 312 and D2N1 313 and the class 1 redundant code C1N1 314 are transferred to the second node 320, to the third node 330, and to the fourth node 340, which are different from the first node 310. Other data (DN2 321, DN3 331, and DN4 341), writing of which is requested respectively to the second node 320, the third node 330, and the fourth node 340, are also processed in the same manner as in the case of the data DN1 311.

Subsequently, at the first node 310, data C2N11 315 and C2N12 316, which are redundant codes in the second stage (second redundant codes), are generated, using data D2N3 332 and D1N4 342, which are transferred from the third node 330 and the fourth node 340 to the first node 310, respectively, for redundancy processing, and a class 1 redundant code C1N2 322, which is generated at the second node 320 and transferred to the first node 310, and the data C2N11 315 and C2N12 316, together with the data blocks D1N1 312 and D2N1 313, are stored in a drive 317 of the first node 310. The data C2N11 315 and the C2N12 316 are referred to as “class 2 redundant codes”.

A group composed of the data blocks D1N1 312 and D2N1 313 and the class 2 redundant codes C2N11 315 and C2N12 316 is referred to as a redundancy group. The same process as done in the first node 310 is carried out also in the second node 320, the third node 330, and the fourth node 340, where the data blocks and the class 2 redundant codes are stored in their respective drives.

Through the above process, data DN1 311, DN2 321, DN3 331, and DN4 341 written to the distributed storage system including four nodes are made redundant and are distributively arranged, together with redundant codes, in a plurality of nodes. As a result, every data can be recovered in the event of a fault involving up to two nodes. The class 2 redundant code is updated each time the data block used for generation of the class 2 redundant code is updated by a writing process.

This procedure is described as an example in which the class 1 redundant code is generated each time rebuilding is executed. However, because the class 1 redundant code is generated in the process of generating the class 2 redundant code for redundancy, the class 1 redundant code is stored in the memory or the drive at a point of time of generation of the class 1 redundant code for redundancy and is updated when the data block used for generation of the class 1 redundant code is updated. By doing this, generating the class 1 redundant code in the event of a fault occurrence becomes unnecessary. The following rebuilding procedure will also be described as a procedure of generating the class 1 redundant code from the data block at each execution of rebuilding. However, when the latest class 1 redundant code based on the latest value of the data block as a generation source is stored in the memory or the drive, the class 1 redundant code kept in storage may be used, instead of generating the class 1 redundant code at each execution of rebuilding. In the description of the rebuilding procedure, description of use of the class 1 redundant code kept in storage is omitted. When the class 1 redundant code is stored in the drive or the memory, the drive or the memory is given a sufficient capacity for storing the class 1 redundant code.

According to the above redundancy processing method, the data block is stored in a node to which the data is written. Therefore, reading the data requires access to this node to which the data is written. Thus, at data reading, data transfer between nodes does not arise, and therefore a performance drop due to data transfer does not result.

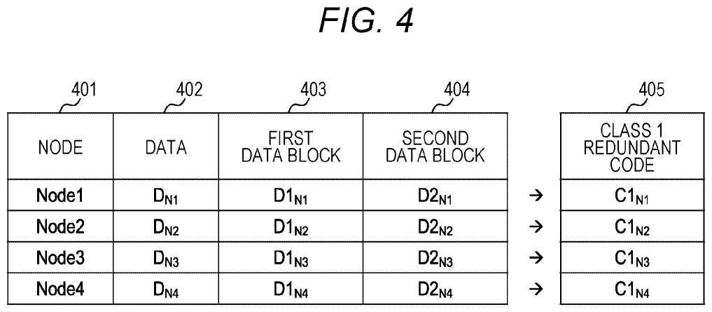

FIG. 4 shows an example of a relationship between data 402 of which writing to each node 401 shown in FIG. 3 is requested, a first data block 403, which is the first one of divided data blocks making up the data 402, a second data block 404, which is the second one of the divided data blocks, the first data block 403, and a class 1 redundant code 405 generated from the first data block 403 and second data block 404.

For example, data DN2 in the second node 320 is divided into a data block D1N2 and a data block D2N2, and a class 1 redundant code C1N2 is generated from the data block D1N2 and the data block D2N2. At each of the first node 310 to the fourth node 340, as a result of redundancy processing, even if the node loses any one of the first data block 403, the second data block 404, and the class 1 redundant code 405, the node can reconstruct the lost data block or the lost class 1 redundant code from two of the first data block 403, the second data block 404, and the class 1 redundant code 405 that are not lost.

The storage control program 210 shown in FIG. 2 may hold the information indicating the relationship between the data, the data block, and the class 1 redundant code, the information being shown in FIG. 4, in the memory or the drive, for example, in the form of a table, divide data into data blocks, referring to the table, and generate a class 1 redundant code. The storage control program 210 may carry out control such that, in the table, a reference numeral is given to a node and to each data block stored in the node, the reference numeral indicating an association between the node and the data block shown in the table, and the data block is stored in the node according to the reference numeral.

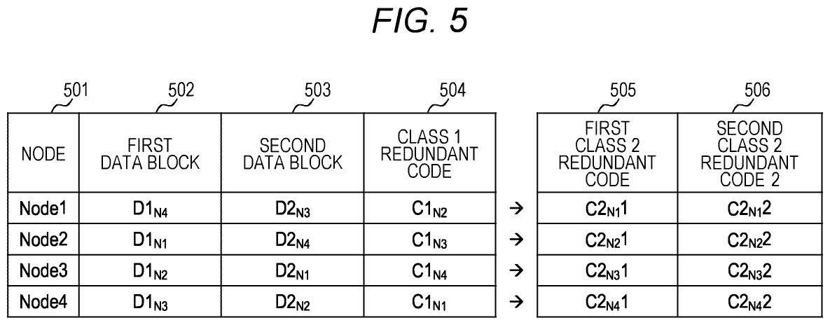

FIG. 5 shows an example of a relationship between data blocks and a class 2 redundant code in a case where the class 2 redundant code is generated from the data blocks shown in FIG. 4, i.e., the first data block 403 and the second second data block 404, and the class 1 redundant code 405.

In this case, a first class 2 redundant code 505 and a second class 2 redundant code 506 are generated from a first data block 502, a second data block 503, and a class 1 redundant code 504 that are transferred to each node 501. For example, in the second node 320, a first class 2 redundant code C2N21 and a second class 2 redundant code C2N22 are generated from a first data block D1N1, i.e., the first data block 502, a second data block D2N4, i.e, the second data block 503, and a class 1 redundant code C1N3.

The storage control program 210 shown in FIG. 2 may hold the information indicating the relationship between the data, the data block, the class 1 redundant code, and the class 2 redundant code, the information being shown in FIG. 5, in the memory or the drive, for example, in the form of a table, and generate the class 2 redundant code from the data blocks and the class 1 redundant code, referring to the table. The storage control program 210 may carry out control such that, in the table, a reference numeral is given to a node and to each data block and a class 2 redundant code that are stored in the node, the reference numeral indicating an association between the node, the data block, and the class 2 redundant code shown in the table, and the data block and class 1 redundant code are stored in the node according to the reference numeral.

For simpler description, FIGS. 3, 4, and 5 each show a case where one redundancy group is arranged in one node. However, a plurality of redundancy groups may be arranged in one node. In such a case, a data block to be made redundant and a class 1 redundant code generated from the data block may be transferred to different nodes different from each other redundancy group by redundancy group, and a class 2 redundant code may be generated in each of the nodes. For each redundancy group, the information indicating the relationship between the data blocks and the redundant codes, the information being shown in FIGS. 4 and 5, may be held in a table or the like and used for redundancy processing.

The example of FIG. 3 is a case where two redundant codes are finally generated from two data blocks, and is therefore referred to as a 2D2P configuration. D stands for a data block, and P stands for a redundant code. Data redundancy processing can be extended to an mDnP configuration using m data blocks and n redundant codes, based on an erasure coding method or the like. For example, in the case of a 3D2P configuration, data of which writing to a node is requested is divided into three data blocks, from which one class 1 redundant code is generated, and the data blocks and redundant code are distributively arranged in a node different from the node to which the data is written.

In each node, two class 2 redundant codes are generated from data blocks and a class 1 redundant code that are transferred from a different node, and are stored, together with three data blocks generated from the data of which writing to each node is requested, in the drive of the node.

In the case of the 3D2P configuration, therefore, the distributed storage system needs at least five nodes. The class 2 redundant codes are generated from the distributively arranged data blocks and class 1 redundant code by the same procedure taken in the case of the 2D2P configuration, and are stored in the drive, which provides protection against a two-node fault. This process applies also to a case different from the case where the number of data m is 3 and the number of redundant codes n is 2.

In general, as the number of data blocks used for redundancy processing gets larger relative to a redundant code to be generated, a drive capacity needed to store the redundant code gets smaller relatively, in which case capacity efficiency is improved but more nodes are required because of an increase in the number of distribution nodes.

FIG. 3 shows an example of data redundancy processing to deal with a node fault. Obviously, by replacing the node with the drive, the data redundancy processing can offer the same data protection also in the case of a fault developing in a drive. In addition, this process can be applied also to a case different from a case where a fault develops at a node or drive, e.g., a case where a node or drive is stopped for a certain period of time for maintenance.

### <Rebuilding Data Block on Substitute Node>

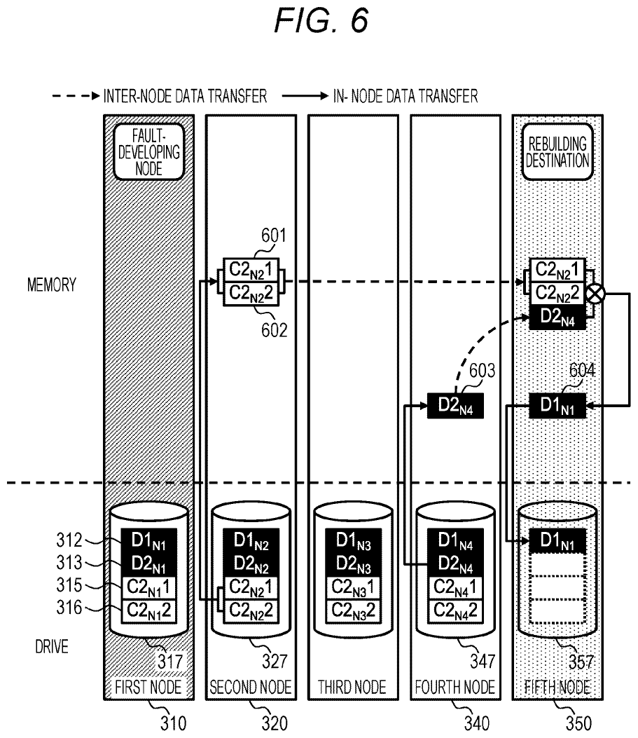

FIG. 6 shows a method by which, in execution of the data redundancy processing method shown in FIG. 3, when a fault develops at one node, a data block identical in content with a data block stored in the fault-developing node is rebuilt on a substitute node having a storage node function. In the following, the same parts as described in the above embodiment will be omitted in further description.

FIG. 6 depicts a process in which when the first node 310 has developed a one node fault, a data block D1N1 312 stored in the first node 310 is rebuilt by using a data block and a class 2 redundant code that are stored in different nodes. It is assumed that the data block D1N1 312, a data block D2N1 313, a class 2 redundant code C2N11 315, and a class 2 redundant code C2N12 316 that are stored in the first node 310 are in an inaccessible state due to the node fault. In this case, the data block D1N1 312 is rebuilt by the following procedures.

Procedure (1): The redundancy processing unit 250 reads a class 2 redundant code C2N21 601 and a class 2 redundant code C2N22 602, from a drive 327 of the second node 320, transfers the class 2 redundant codes C2N21 601 and C2N22 602 to the memory, and then transfers them to a fifth node 350 having the storage node function, the fifth node 350 being a substitute node substituting for the fault-developing first node 310.

Procedure (2): The redundancy processing unit 250 reads a data block D2N4 603 from a drive 347 of the fourth node 340, transfers the data block D2N4 603 to the memory, and then transfers it to the fifth node 350.

Procedure (3): In the fifth node 350, the redundancy processing unit 250 reconstructs a data block D1N1 604 identical in content with the data block D1N1 312 stored in the fault-developing first node 310, from the class 2 redundant codes C2N21 601 and C2N22 602 and the data block D2N4 603.

Procedure (4): The redundancy processing unit 250 stores the data block D1N1 604 of the fifth node 350 in a drive 357 thereof.

Thus, when the data block is reconstructed, inter-node data transfer occurs, by which one data block and two class 2 redundant codes are transferred to the substitute node as a rebuilding destination. After the data and class 2 redundant codes stored in the fault-developing node are rebuilt on the substitute node, the storage control program 210 carries out a process of changing the configuration of the distributed storage system and switching from the fault-developing node to the substitute node. The process of switching from the fault-developing node to the substitute node remains the same in the description to follow, and therefore will be omitted in further description.

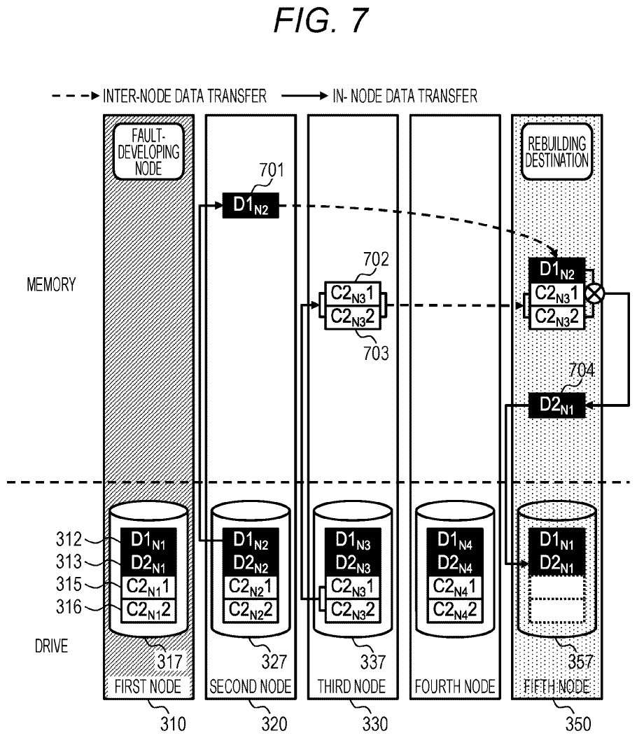

FIG. 7 depicts a method by which, in execution of the data redundancy processing method of FIG. 3, when the first node 310 has developed a one node fault as in the case of FIG. 6, a data block D1N1 313 stored in the first node 310 is rebuilt by using a data block and a class 2 redundant code that are stored in different nodes.

FIG. 7 shows a state in which by the procedures indicated in FIG. 6, reconstruction of the data block D1N1 is already completed and the data block D1N1 is already stored in the drive 357 of the fifth node 350, which is the substitute node as the rebuilding destination. In this embodiment, reconstruction of the data block D1N1 is executed first. However, in a case where a plurality of nodes develop failures, which case will be described later, any rebuilding target may be rebuilt first, except a case where the order of execution of rebuilding affects proper execution of rebuilding.

Procedure (1): The redundancy processing unit 250 reads a data block D1N2 701 from the drive 327 of the second node 320, transfers the data block D1N2 701 to the memory, and then transfers it to the fifth node having the storage node function and serving as the substitute node substituting for the fault-developing first node 310.

Procedure (2): The redundancy processing unit 250 reads a class 2 redundant code C2N31 702 and a class 2 redundant code C2N32 703, from the drive 337 of the third node 330, transfers the class 2 redundant codes C2N31 702 and C2N32 703 to the memory, and then transfers them to the fifth node 350.

Procedure (3): In the fifth node 350, the redundancy processing unit 250 reconstructs a data block D2N1 704 identical in content with the data block D2N1 313 stored in the fault-developing first node, from the data block D1N2 701 and the class 2 redundant codes C2N31 702 and C2N32 703.

Procedure (4): The redundancy processing unit 250 stores the data block D2N1 704 of the fifth node 350 in the drive 357 thereof.

As in the case of FIG. 6, when the data block is reconstructed, inter-node data transfer occurs, by which one data block and two class 2 redundant codes are transferred to the substitute node serving as the rebuilding destination.

As indicated in FIGS. 6 and 7, to reconstruct a data block stored in a fault-developing node, transfer of m+2n pieces of data occurs in redundancy processing in the mDnP configuration.

### <Rebuilding a Class 2 Redundant Code on a Substitute Node>

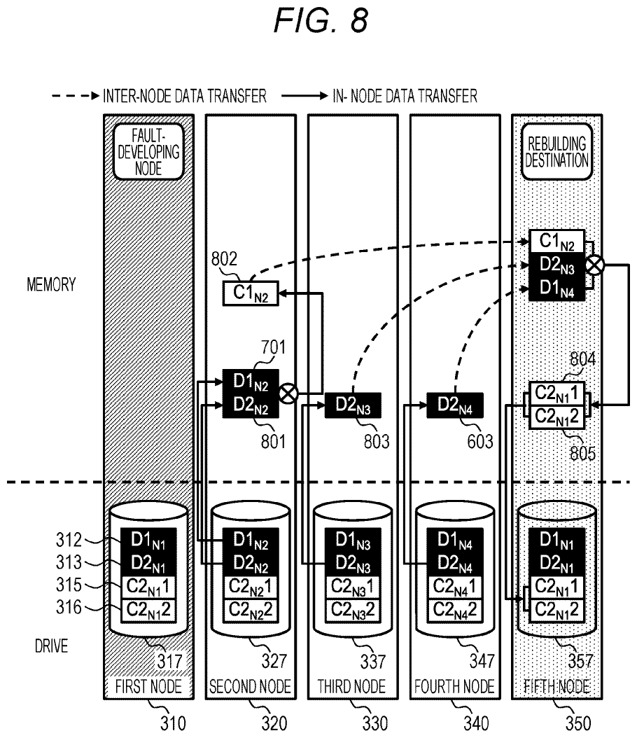

FIG. 8 depicts a procedure by which, in execution of the data redundancy processing method shown in FIG. 3, when the first node 310 has developed a one node fault, class 2 redundant codes C2N11 315 and C2N12 316 stored in the first node 310 are rebuilt by using a data block and a class 2 redundant code that are stored in different nodes, as in the cases of FIGS. 6 and 7.

FIG. 8 shows a state in which by the procedures indicated in FIGS. 6 and 7, reconstruction of the data blocks D1N1 and D2N1 is already completed and the data block D1N1 and D2N1 are already stored in the drive 357 of the fifth node 350, which is the substitute node as the rebuilding destination. In this embodiment, reconstruction of the data blocks D1N1 and D2N1 is executed first. However, in a case where a plurality of nodes develop faults, which case will be described later, any rebuilding target may be rebuilt first, except a case where the order of execution of rebuilding affects proper execution of rebuilding.

Procedure (1): The redundancy processing unit 250 reads data blocks D1N2 701 and D2N2 801 from the drive 327 of the second node 320, transfers the data blocks D1N2 701 and D2N2 801 to the memory, and then generates a class 1 redundant code C1N2 802, using the data blocks D1N2 701 and D2N2 801.

Procedure (2): The redundancy processing unit 250 transmits the generated class 1 redundant code C1N2 802 from the second node 320 to the fifth node 350 having the storage node function, the fifth node 350 being the substitute node substituting for the fault-developing first node 310.

Procedure (3): The redundancy processing unit 250 reads a data block D2N3 803 from a drive 337 of the third node 330, transfers the data block D2N3 803 to the memory, and then transfers it to the fifth node 350 serving as the substitute node.

Procedure (4): The redundancy processing unit 250 reads a data block D1N4 603 from a drive 347 of the fourth node 340, transfers the data block DIN4 603 to the memory, and then transfers it to the fifth node 350 serving as the substitute node.

Procedure (5): In the fifth node 350, the redundancy processing unit 250 reconstructs a class 2 redundant code C2N11 804 and a class 2 redundant code C2N12 805 identical in content respectively with the class 2 redundant code C2N11 315 and the class 2 redundant code C2N12 316 that are stored in the fault-developing node310, from the class 1 redundant code C1N2 802, the data block D2N3 803, and the data block D1N4 603, and stores the class 2 redundant codes C2N11 804 and C2N12 805 in the drive 357 of the fifth node 350.

In the case of redundancy processing in the 2D2P configuration shown in FIG. 8, when class 2 redundant codes are reconstructed, inter-node data transfer occurs, by which two data blocks and one class 1 redundant code are transferred to the substitute node serving as the rebuilding destination. In the case of redundancy processing in the mDnP configuration, transfer of m data blocks plus (n−1) redundant codes occurs.

According to the procedures of FIGS. 6, 7, and 8, data identical in content with the data block and class 2 redundant codes stored in the fault-developing node is rebuilt in the fifth node 350 serving as the substitute node.

The above redundancy processing in the mDnP configuration allows reconstruction of data and class 2 redundant codes in the event of simultaneous development of n node faults. FIGS. 6, 7, and 8 show the rebuilding procedure in the case where the number of fault-developing nodes is one (one node fault). However, even in a case where the number of fault-developing nodes is n, by executing the same rebuilding procedure, data blocks and class 2 redundant codes stored in the fault-developing nodes can be rebuilt from data blocks and class 2 redundant nodes stored in other nodes different from the fault-developing nodes.

For example, a rebuilding procedure for a case where the first node 310 and the second node 320 shown in FIGS. 3, 6, 7, and 8 develop a failure and become inaccessible will be described. In this embodiment, description will be made with reference numerals omitted in some cases on a necessary basis.

Procedure (1): The redundancy processing unit 250 generates a class 1 redundant code C1N4 from a data block D1N4 and a data block D2N4 that are a first data block 403 and a second data block 404 stored in the fourth node 340. It is assumed that data necessary for reconstruction are put together by being transferred within a given node or transferred to a memory of any different node and that a reconstruction operation is carried out on the memory of the node. From the following description, an explanation of a transfer operation will be omitted.

Procedure (2): For example, the redundancy processing unit 250 reconstructs a data block D1N2 of the second node 320 and a data block D2N1 of the first node, from the class 1 redundant code C1N4 and class 2 redundant codes C2N31 and C2N32 stored in the third node 330.

Procedure (3): The redundancy processing unit 250 reconstructs a data block D2N2 of the second node 320 and a class 1 redundant code C1N1, from a data block D1N3 stored in the third node and class 2 redundant codes C2N41 and C2N42 stored in the fourth node 340.

Procedure (4): The redundancy processing unit 250 reconstructs a data block D1N1 of the first node 310, from the data block D2N1 of the first node 310, the data block D2N1 having been reconstructed by the above procedure (2), and the class 1 redundant code C1N1.

Procedure (5): The redundancy processing unit 250 generates a class 1 redundant code C1N3 from the data blocks D1N3 and D2N3 of the third node 330.

Procedure (6): The redundancy processing unit 250 reconstructs class 2 redundant codes C2N21 and C2N22 of the second node 320, from the data block D1N1 of the first node 310, the data block D1N1 having been reconstructed by the procedure (4), a data block D2N4 of the second node 320, and the class 1 redundant code C1N3 generated by the procedure (5).

Procedure (7): The redundancy processing unit 250 generates a class 1 redundant code C1N2 from the data block D1N2 of the second node, the data block D1N2 having been rebuilt by the procedure (2), and the data block D2N2 of the second node 320, the data block D2N2 having been reconstructed by the procedure (3).

Procedure (8): The redundancy processing unit 250 reconstructs the class 2 redundant codes C2N11 and C2N12 of the first node 340, from the data block D1N4 stored in the fourth node 310, the data block D2N3 stored in the third node, and the class 1 redundant code C1N2 generated by the procedure (7).

As described above, even when a fault develops at two nodes, data blocks and class 2 redundant codes stored in the fault-developing nodes can be reconstructed in order. FIGS. 6, 7, and 8 show an exemplary case where a fault has developed at the first node 310 and the second node 320. In a different case where a fault develops at other nodes, the same rebuilding procedure is carried out as well. In addition, in the case of, for example, the mDnP redundancy configuration, rebuilding can be carried out by executing the same procedure.

As shown in FIGS. 6, 7, and 8, a data block stored in a fault-developing node and a data block and a class 1 redundant code needed for reconstruction of a class 2 redundant code are transferred to a node (substitute node) having the storage node function and substituting for the failure-developing node, and the data block and the class 2 redundant code are reconstructed on the substitute node. For example, to reconstruct the data block D1N1 stored in the first node having developed a fault, the process shown in FIG. 6. is carried out, according to which the second data block D2N4 603 stored in the fourth node 340 and the class 2 redundant codes C2N21 601 and C2N22 602 stored in the second node are transferred to the fifth node 350 serving as the substitute node, where the data block D1N1 604 is reconstructed. Likewise, to reconstruct the data D2N1 stored in the first node 310 having developed a fault, the process shown in FIG. 7 is carried out, according to which the first data block D1N2 701 stored in the second node 320 and the class 2 redundant codes C2N31 702 and C2N32 703 stored in the third node are transferred to the fifth node 350 serving as the substitute node, where the data block D2N1 704 is reconstructed. In the mDnP configuration, when m data blocks stored in the first node 310 are reconstructed, m data blocks and 2n class 2 redundant codes are transferred, and therefore the number of data transferred to the substitute node is m+2n in total.

Likewise, to reconstruct the class 2 redundant codes, the process shown in FIG. 8 is carried out, according to which the second data block D2N3 803 stored in the third node 330, the second data block D2N4 603 stored in the fourth node 340, and the class 1 redundant code C1N2 802 generated from the first and second data blocks D1N2 701 and D2N2 801 stored in the second node 320 are transferred to the fifth node 350 serving as the substitute node, where the class 2 redundant codes C2N11 804 and C2N12 805 are reconstructed. In the mDnP configuration, when class 2 redundant codes are reconstructed, m data blocks and (n−1) class 1 redundant codes are transferred, and therefore the number of data transferred to the substitute node is m+(n−1) in total.

Thus, according to the above description with reference to FIGS. 6, 7, and 8, the number of data transferred to the fifth node 350 serving as the substitute node, the number of data being needed to reconstruct data blocks and class 2 redundant codes of each redundancy group stored in the first node 310, is 2m+(3n−1).

When a plurality of redundancy groups are stored in the first node 310, data blocks and class 1 redundant codes needed to reconstruct all data blocks and class 2 redundant codes belonging to the redundancy groups are transferred to the fifth node 350 serving as the substitute node, which is a rebuilding destination. In this case, the number of data transferred to the substitute node that is required for rebuilding is given as: number of redundancy groups×(2m+(3n−1). This indicates a fact that at execution of rebuilding, data transfer concentrates at the substitute node, i.e., rebuilding destination. In addition, a load of rebuilding class 2 redundant codes concentrates at the substitute node.

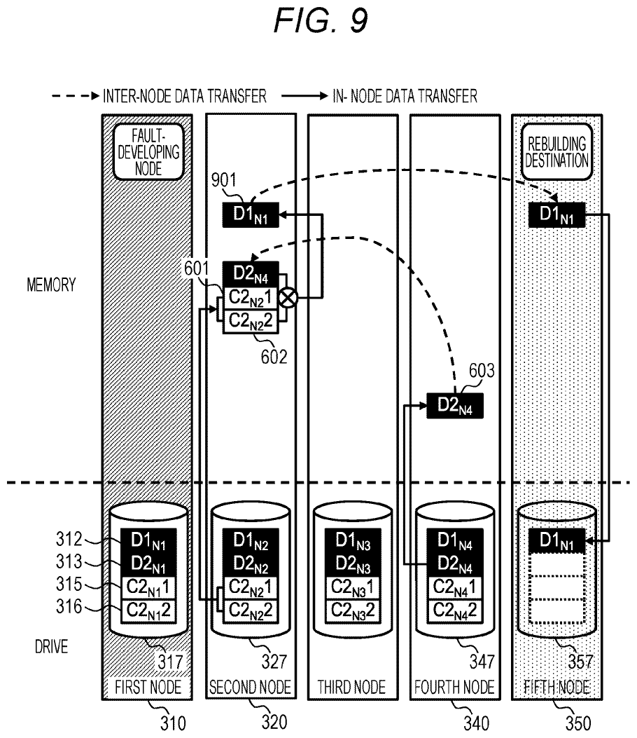

In contrast, FIG. 9 shows a rebuilding method of this embodiment by which in execution of the data redundancy processing method shown in FIG. 3, data inflow to the substitute node is reduced at execution of data block rebuilding. The controller determines whether or not to execute reconstruction of a data block and a class 2 redundant code at a substitute node. When determining executing the reconstruction at the substitute node, the controller transfers data necessary for the restoration, from respective storage devices of a plurality of nodes to the substitute node. When determining not executing the reconstruction at the substitute node, the controller selects a specific node that executes the reconstruction, transfers the data necessary for the restoration, from respective storage devices of the nodes to the specific node, executes the reconstruction at the specific node, and stores the reconstructed class 2 redundant code in the substitute node.

In FIG. 6 shown above, the process to carry out when the first node 310 develops a one node fault is described. According to the process, the data block D1N1 312 stored in the first node 310 is rebuilt by using data blocks and a class 2 redundant code that are stored in different nodes.

It is now assumed that the data block D1N1 312, the data block D2N1 313, the class 2 redundant code C2N11 315, and the class 2 redundancy code C2N12 316 that are stored in the first node 310 are in an inaccessible state because of the node fault. At this time, the data block D1N1 312 stored in the first node 310 is rebuilt by the following procedures.

Procedure (1): The redundancy processing unit 250 reads the class 2 redundant code C2N21 601 and the class 2 redundant code C2N22 602 from the drive 327 of the second node 320, and transfers the class 2 redundant codes C2N21 601 and C2N22 602 to the memory.

Procedure (2): The redundancy processing unit 250 reads the data block D2N4 603 from the drive 347 of the fourth node 340, transfers the data block D2N4 603 to the memory, and then transfers it to the second node 320.

Procedure (3): In the second node 320, the redundancy processing unit 250 reconstructs a data block D1N1 901 identical in content with the data block D1N1 312 stored in the fault-developing first node 310, from the class 2 redundant codes C2N21 601 and C2N22 602 and the data block D2N4 603.

Procedure (4): The redundancy processing unit 250 transfers the data block D1N1 901 to the fifth node 350 having the storage node function, the fifth node 350 being a substitute node substituting for the fault-developing failed first node 310, and stores the data block D1N1 901 in the drive 357.

Thus, when a data block is reconstructed, inter-node data transfer of transferring one data block to the substitute node, i.e., rebuilding destination arises. After the data and class 2 redundant codes stored in the fault-developing node are rebuilt on the substitute node, the storage control program 210 carries out a process of changing the configuration of the distributed storage system and switching from the fault-developing node to the substitute node. The process of switching from the fault-developing node to the substitute node remains the same in the description to follow, and therefore will be omitted in further description.

### <Rebuilding Data Block on Substitute Node>

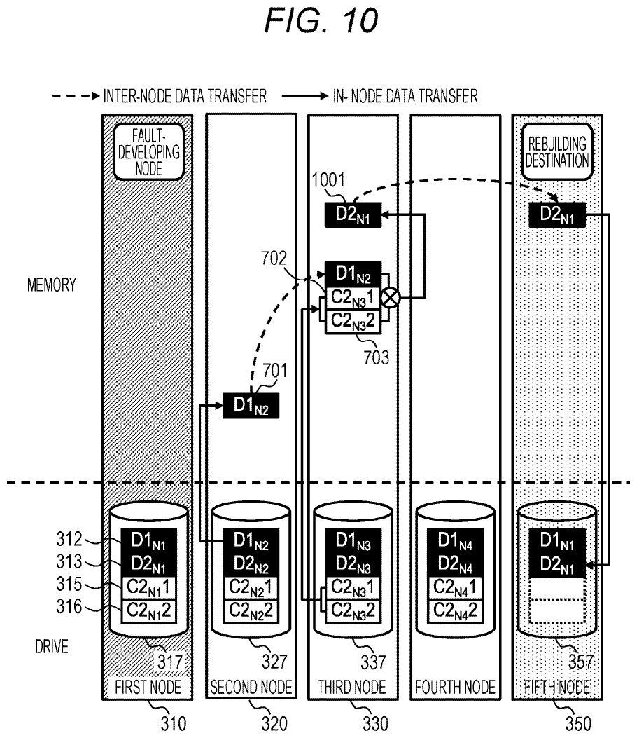

FIG. 10 shows a rebuilding method of this embodiment by which in execution of the data redundancy processing method shown in FIG. 3, when the first node 310 has developed a one node fault, data inflow to the substitute node is reduced at execution of data block rebuilding, as in the case of FIG. 9. FIG. 10 shows a state in which by the procedure shown in FIG. 9, the data block D1N1 has been reconstructed and is already stored in the drive 357 of the fifth node 350 serving as the substitute node, i.e., rebuilding destination.

In this embodiment, reconstruction of the data block D1N1 is executed first. However, any rebuilding target may be rebuilt first, except a case to be described later where a plurality of nodes develop a failure, which is a case where the order of execution of reconstruction affects execution of proper reconstruction.

Procedure (1): The redundancy processing unit 250 reads the data block D1N2 701 from the drive 327 of the second node 320, transfers the data block D1N2 701 to the memory, and then transfers it to the third node 330.

Procedure (2): The redundancy processing unit 250 reads the class 2 redundant code C2N31 702 and the class 2 redundant code C2N32 703 from the drive 337 of the third node 330, and transfers the class 2 redundant codes C2N31 702 and C2N32 703 to the memory.

Procedure (3): In the third node 330, the redundancy processing unit 250 reconstructs a data block D2N1 1001 identical in content with the data block D2N1 313 stored in the fault-developing first node, from the data block D1N2 701 and the class 2 redundant codes C2N31 702 and C2N32 703.

Procedure (4): The redundancy processing unit 250 transfers the data block D2N1 1001 to the fifth node 350 having the storage function, the fifth node 350 being the substitute node substituting for the fault-developing first node 310, and stores the data block D2N1 1001 in the drive 357.

As in the case of FIG. 9, when the data block is reconstructed, inter-node data transfer of transferring one data block to the substitute node, i.e., rebuilding destination arises.

As indicated in both FIGS. 9 and 10, reconstructing the data block stored in the fault-developing node results in transfer of m pieces of data in redundancy processing in the mDnP configuration.

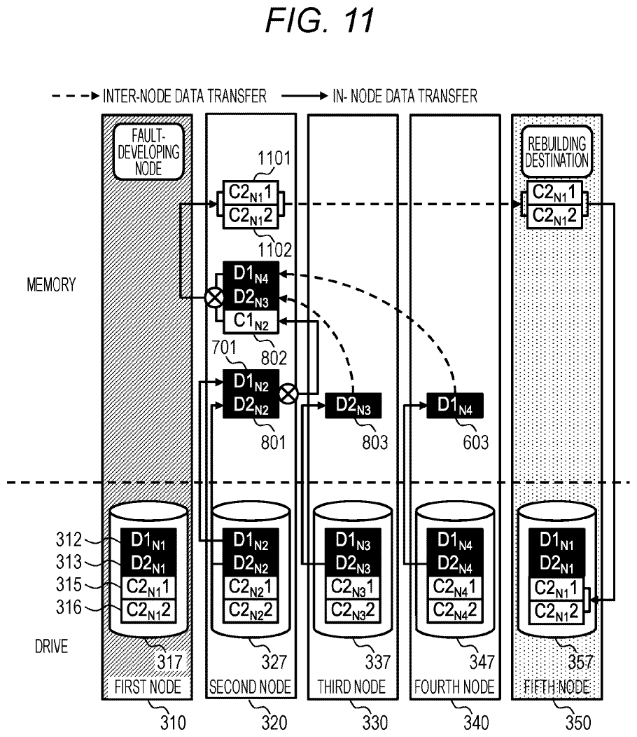

FIG. 11 shows a rebuilding method of this embodiment by which data inflow to the substitute node is reduced when a redundant code is rebuilt. FIG. 11 shows a procedure by which in execution of the data redundancy processing method shown in FIG. 3, when the first node 310 has developed a one node failure, the class 2 redundant code C2N11 315 and the class 2 redundant code C2N12 316 that are stored in the first node 310 are reconstructed by using data blocks and class 2 redundant codes that are stored in different nodes, as in the case of FIG. 8.

FIG. 11 shows a state in which by the procedures shown in FIGS. 9 and 10, the data blocks D1N1 and D2N1 have been reconstructed and are already stored in the drive 357 of the fifth node 350 serving as the substitute node, i.e., rebuilding destination, as in the case of FIG. 8. In this embodiment, reconstruction of the data blocks D1N1 and D2N1 is executed first. However, any rebuilding target may be rebuilt first, except a case to be described later where a plurality of nodes develop a failure, which is a case where the order of execution of reconstruction affects execution of proper reconstruction.

### <Rebuilding a Class 2 Redundant Code on a Substitute Node>

FIG. 11 shows a case where when the first node 310 has developed a fault, the class 2 redundant code C2N11 315 and the class 2 redundant code C2N12 316 that are stored in the fault-developing first node 310 are rebuilt on the fifth node 350 serving as the substitute node, by the following procedures.

Procedure (1): The redundancy processing unit 250, by the same procedure as shown in FIG. 8, first reads the data blocks D1N2 701 and D2N2 801 from the drive 327 of the second node 320, transfers the data blocks D1N2 701 and D2N2 801 to the memory, and generates the class 1 redundant code C1N2 802, using the data blocks D1N2 701 and D2N2 801.

Procedure (2): The redundancy processing unit 250 transfers the data block D2N3 803 stored in the drive 337 of the third node 330 to the memory, and then transfers the data block D2N3 803 to the second node 320.

Procedure (3): The redundancy processing unit 250 transfers the data block D1N4 603 stored in the drive 347 of the fourth node 340 to the memory, and then transfers the data block D1N4 603 to the second node 320.

Procedure (4): In the second node 320, the redundancy processing unit 250 reconstructs a class 2 redundant code C2N11 1101 and a class 2 redundant code C2N12 1102, from the class 1 redundant code C1N2 802 generated, the data block D2N3 803 transferred from the third node 330, and the data block D1N4 603 transferred from the fourth node 340.

Procedure (5): The redundancy processing unit 250 transfers the class 2 redundant code C2N11 1101 and class 2 redundant code C2N12 1102 that have been reconstructed, to the fifth node serving as the substitute node, i.e., rebuilding destination, and stores the class 2 redundant codes C2N11 1101 and C2N12 1102 in the drive 357 of the fifth node.

In this case, because the class 2 redundant codes C2N11 1101 and C2N12 1102 are reconstructed in the second node, data transferred to the fifth node 350 serving as the substitute node is the class 2 redundant codes only. In this redundancy processing in the mDnP configuration, the number of data transferred to the substitute node that is required for reconstruction is m+n, which is the sum of the number of data transferred m required for restoration of the data block, which is described with reference to FIGS. 9 and 10, and the number of class 2 redundant codes transferred n, which is described with reference to FIG. 11. The number of data transferred to the substitute node in a case where a plurality of redundancy groups are present is given as: the number of redundancy groups×(m+n). Compared with the method of FIG. 8, the method of FIG. 11 of this embodiment reduces the number of data transferred, to (m+n)/(2m+(3n−1). For example, in the case of a 4D2P configuration, the number of data transferred is reduced to (4+2)/(8+6−1)=6/13.

In addition, in a case where a plurality of redundancy groups are present, a data block to be made redundant and a class 1 redundant code generated from the data block are transferred to a different node for each redundancy group, and a class 2 redundant code is generated in each node, as described above. As a result, a process of reconstructing the class 2 redundant code is distributively executed at a plurality of nodes, which reduces the load of the rebuilding process at the substitute node.

### <Rebuilding Data Block on Substitute Node>

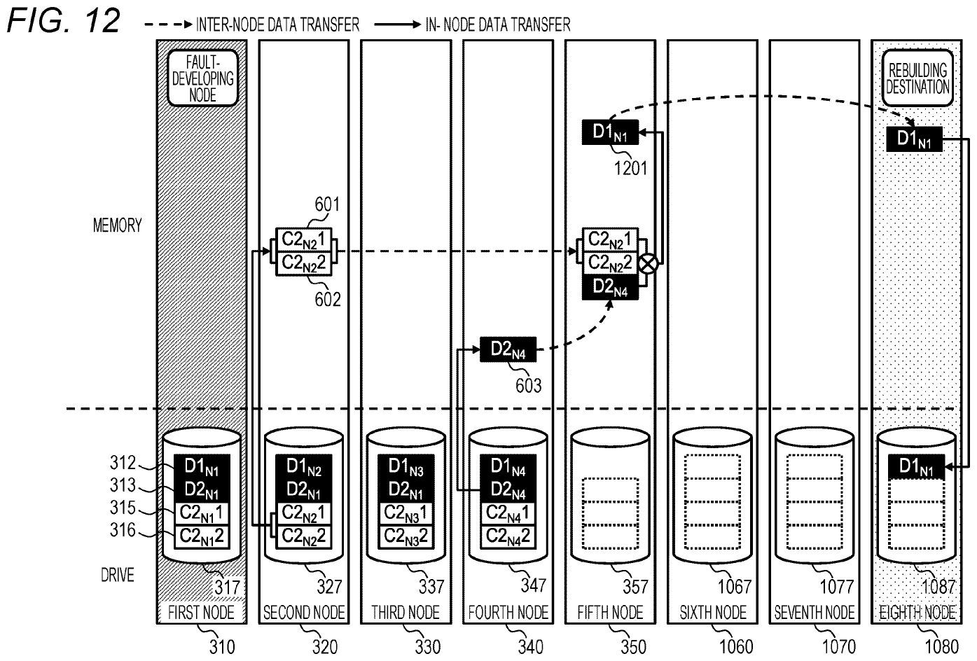

FIG. 12 depicts an example in which in the case of FIG. 9, a node that rebuilds a data block is selected based on a specific condition. In the case of FIG. 9, reconstruction of the data block D1N1 312 is executed at the second node 320 that, as the node that executes reconstruction of the data block D1N1 312, stores the class 2 redundant codes used for the reconstruction.

However, a node that rebuilds a data block or a class 2 redundant code is not limited to this example. FIG. 12 shows, for example, a case where the number of nodes is 8. In this case, for example, a plurality of redundancy groups are arranged respectively in different nodes, and data blocks and class 2 redundant codes belonging to redundancy groups different from data blocks and class 2 redundant codes stored respectively in the drives 317, 327, 337, and 347, which are an example of the storage devices of the first node 310, the second node 320, the third node 330, and the fourth node 340 shown in FIGS. 3, 6, 7, 8, 9, 10, and 11, are arranged respectively in drives 357, 1067, and 1077 of a fifth node 350, a sixth node 1060, and a seventh node 1070. This puts the data blocks in a distributed arrangement, thus allowing distributed execution of I/O process requests from the host server. The drives 357, 1067, and 1077 of the fifth node 350, the sixth node 1060, and the seventh node 1070 may each be provided with a new node for rebuilding, which has the storage node function.

In the case of FIG. 9, rebuilding of the data block D1N1 stored in the drive 317 of the fault-developing first node is executed at the second node 320. In the case of FIG. 12, however, the rebuilding is executed at the fifth node 350.

Procedure (1): The redundancy processing unit 250 reads the class 2 redundant code C2N21 601 and the class 2 redundant code C2N22 602 from the drive 327 of the second node 320, transfers the class 2 redundant codes C2N21 601 and C2N22 to the memory, and then transfers them to the fifth node 350.

Procedure (2): The redundancy processing unit 250 reads the data block D2N4 603 from the drive of the fourth node, transfers the data block D2N4 603 to the memory, and then transfers it to the fifth node 350.

Procedure (3): In the fifth node 350, the redundancy processing unit 250 reconstructs a data block D1N1 1201 identical in content with the data block D1N1 312 stored in the fault-developing first node 310, from the class 2 redundant codes C2N21 601 and C2N22 602 and the data block D2N4 603.

Procedure (4): The redundancy processing unit 250 transfers the data block D1N1 1201 to the eighth node 1050 having the storage function, the eighth node 1050 substituting for the fault-developing first node 310, and stores the data block D1N1 in the drive 1087.

### <Rebuilding Data Block Selected Based on Specific Condition, on Substitute Node>

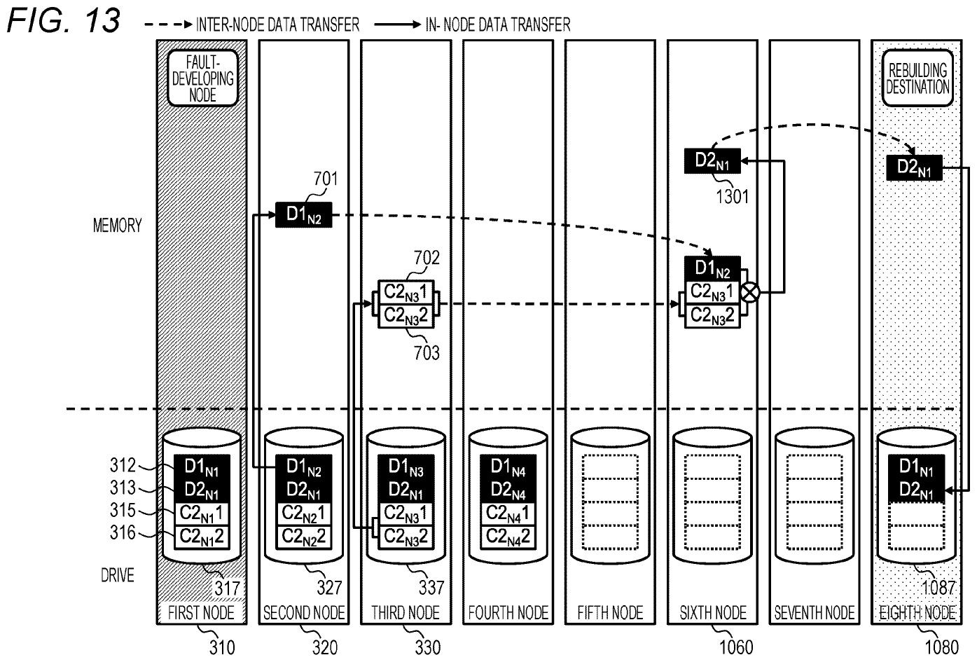

FIG. 13 shows an example in which, in the case of FIG. 10, a node that rebuilds a data block is selected based on a specific condition. FIG. 13 shows an example in which a data block is rebuilt in an 8-node configuration, as in the case of FIG. 12. FIG. 10 shows the example in which reconstruction is executed in the third node 330 that stores the class 2 redundant codes used for rebuilding, as a node that executes reconstruction of the data block D2N1 313. In the example of FIG. 13, reconstruction is executed at the sixth node 360, based on the following procedures.

Procedure (1): The redundancy processing unit 250 reads the data block D1N2 701 from the drive 327 of the second node 320, transfers the data block D1N2 701 to the memory, and then transfers it to the sixth node 1060.

Procedure (2): The redundancy processing unit 250 reads the class 2 redundant code C2N31 702 and the class 2 redundant code C2N32 703 from the drive 337 of the third node 330, transfers the class 2 redundant codes C2N31 702 and C2N32 703 to the memory, and then transfers them to the sixth node 1060.

Procedure (3): In the sixth node 1060, the redundancy processing unit 250 reconstructs a data block D2N1 1301 identical in content with the data block D2N1 313 stored in the fault-developing first node, from the data block D1N2 701 and the class 2 redundant codes C2N31 702 and C2N32 703.

Procedure (4): The redundancy processing unit 250 transfers the data block D2N1 1301 to an eighth node 1080 having the storage node function, the eighth node 1080 being a substitute node substituting for the fault-developing first node 310, and stores the data block D2N1 1301 in a drive 1087.

### <Rebuilding Class 2 Redundant Code Selected Based on Specific Condition, on Substitute Node>

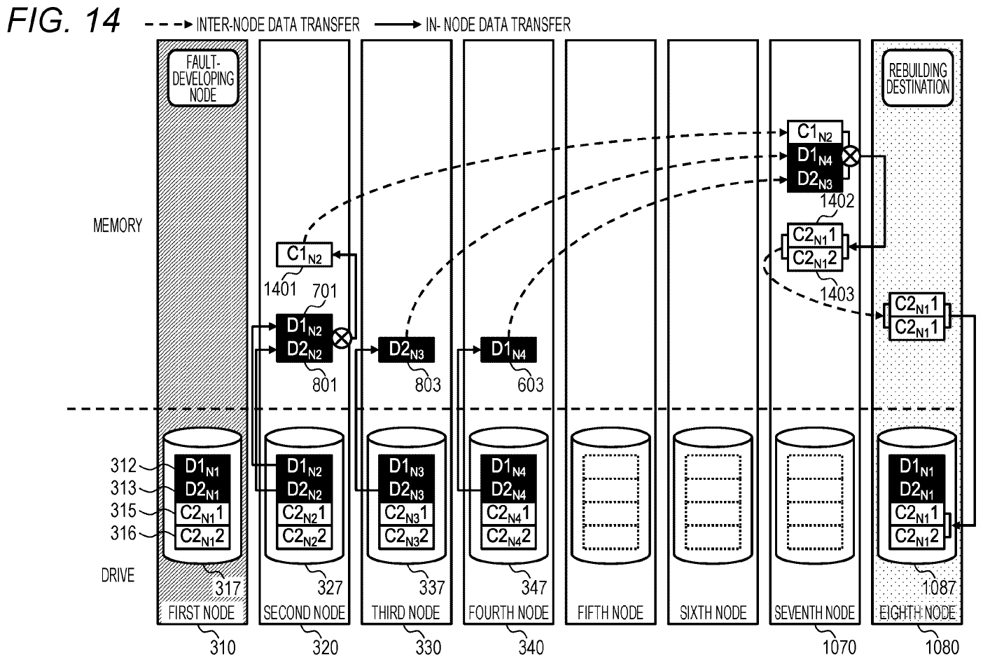

FIG. 14 shows an example in which, in the case of FIG. 11, the redundancy processing unit 250 selects a specific node that rebuilds a class 2 redundant code, based on a specific condition. FIG. 14 shows an example in which a class 2 redundant code is rebuilt in the 8-node configuration, as the data block is in the cases of FIGS. 12 and 13. In the case of FIG. 11, reconstruction is executed at the second node 320 that stores data blocks used for generation of a class 1 redundant code, as a node that executes reconstruction of the class 2 redundant code C2N11 315 and the class 2 redundant code C2N12 316. In the example of FIG. 14, reconstruction is executed at the seventh node 1070, based on the following procedures.

Procedure (1): The redundancy processing unit 250, by the same procedure as shown in FIG. 11, first reads the data blocks D1N2 701 and D2N2 801 from the drive 327 of the second node 320, transfers the data blocks D1N2 701 and D2N2 801 to the memory, and generates a class 1 redundant code C1N2 1401, using the data blocks D1N2 701 and D2N2 801.

Procedure (2): The redundancy processing unit 250 transfers the class 1 redundant code C1N2 1201 to the seventh node 1070.

Procedure (3): The redundancy processing unit 250 transfers the data block D2N3 803 stored in the drive 337 of the third node 330, to the memory, and then transfers the data block D2N3 803 to the seventh node 1070.

Procedure (4): The redundancy processing unit 250 transfers the data block D1N4 603 stored in the drive 347 of the fourth node 340, to the memory, and then transfers the data block D1N4 603 to the seventh node 1070.

Procedure (5): In the seventh node 1070, the redundancy processing unit 250 reconstructs a class 2 redundant code C2N11 1402 and a class 2 redundant code C2N12 1403, from the class 1 redundant code C1N2 1401 transferred from the second node 320, the data block D2N3 803 transferred from the third node 330, and the data block D1N4 603 transferred from the fourth node 340.

Procedure (6): The redundancy processing unit 250 transfers the class 2 redundant code C2N11 1402 and class 2 redundant code C2N12 1403 that have been reconstructed, to the eighth node 1080 having the storage function, the eighth node 1080 being the substitute node, i.e., rebuilding destination, and stores the class 2 redundant codes C2N11 1402 and C2N12 1403 in the drive 1087.

For example, based on a loaded state of a node, the redundancy processing unit 250 selects a specific node (the fifth node 350 in this embodiment) that reconstructs the data block D1N1 1201 in the case of FIG. 12, a specific node (the sixth node 1060 in this embodiment) that reconstructs the data block D2N1 1301 in the case of FIG. 13, and a specific node (the seventh node 1070 in this embodiment) that reconstructs the class 2 redundant code C2N11 1402 and the class 2 redundant code C2N12 1403 in the case of FIG. 14.

The state of a node may be acquired by the node information acquisition unit 260 included in the storage control program 210 of FIG. 2. In this embodiment, part or the whole of reconstruction of the data block described with reference to FIGS. 12 and 13 and of reconstruction of the class 2 redundant codes described with reference to FIG. 14 may be executed in the same node.

### <Select Data Block and Class 2 Redundant Code, Based on Loaded State of Node>

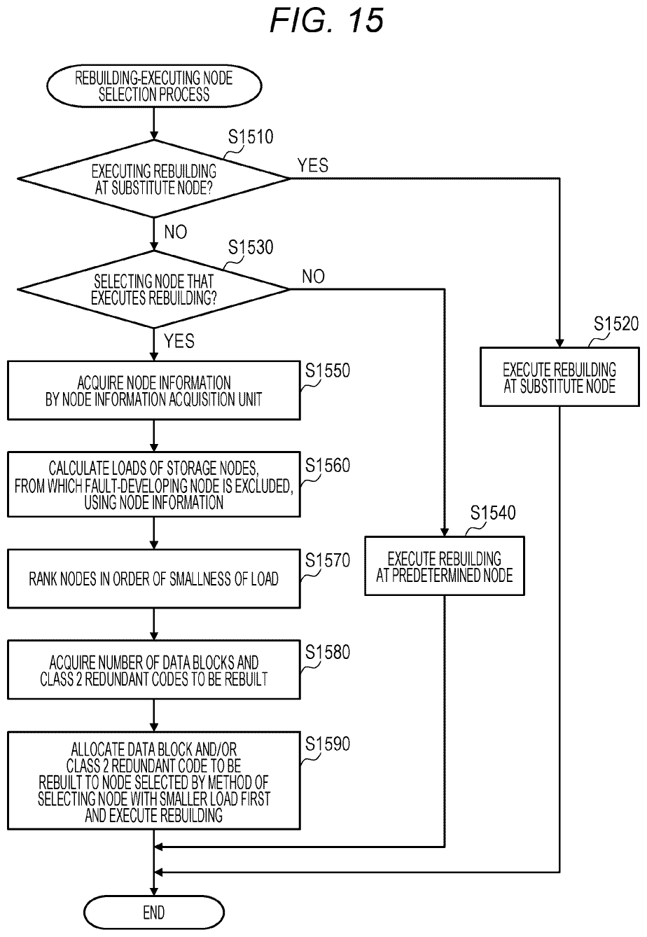

FIG. 15 shows an example of a procedure of selecting a node that reconstructs a data block and a class 2 redundant code, based on a loaded state of the node.

First, the redundancy processing unit 250 determines whether or not to execute reconstruction at a substitute node (step S1510). When determining executing the reconstruction at the substitute node, the redundancy processing unit 250 transfers data necessary for the reconstruction to the substitute node, and executes the reconstruction at the substitute node (step S1520). When determining not executing the reconstruction at the substitute node, on the other hand, the redundancy processing unit 250 determines whether or not to select a specific node that executes the reconstruction (step S1530).

When determining not selecting a specific node that executes the reconstruction, the redundancy processing unit 250 executes the reconstruction at a node specified by, for example, a predetermined method based on data arrangement or the like, as shown in FIGS. 9, 10, and 11 (step S1540).

When determining selecting a specific node that executes the reconstruction, the redundancy processing unit 250 acquires node information on each node, for example, from the node information acquisition unit 260 or the like included in the storage control program 210 shown in FIG. 2 (step S1550).

Node information is, for example, hardware operation information acquired at the point of start of the reconstruction, which is any one of or any combination of these pieces of information: a CPU usage rate, a memory usage rate, a band usage rate of network hardware, such as a network interface card (NIC) each node has, a drive usage rate, a CPU temperature, an operating frequency, a supply voltage to a computer, and a fan rotating speed.

In addition to node information acquired by the node information acquisition unit 260, for example, information on the hardware performance of a node, such as the number of CPU cores and a specified band performance of the NIC, may also be selected as the node information. Using at least one of these pieces of information, the redundancy processing unit 250 calculates respective node loads of storage nodes in operation or standby, from which a fault-developing storage node is excluded, among the storage nodes making up the distributed storage system, and selects a specific storage node according to the calculated node loads (step S1560).

The node load may be calculated by using, for example, a single piece of the above node information acquired by the node information acquisition unit 260. Alternatively, the node load may be calculated by using a combination of multiple pieces of information, that is, some or all of the node information. Examples of using a single piece of the node information includes, for example, a case of using a CPU usage rate average of each CPU core of each node or a CPU usage rate of a CPU core with a lowest operation rate, as criteria for determining a node load, and a case of using a network band usage rate indicating a ratio of consumption of network band performance by I/O from the host server or I/O between storage nodes.

Methods of using a combination of multiple pieces of the above information includes, for example, a method of adding a preset weight to the CPU usage rate or the network usage rate and calculating its arithmetic mean or geometric mean, and a method of using a mathematical formula based on a statistical analysis of measurements of a load tendency, a determination formula based on machine learning, or the like. In addition, a threshold may be set with respect to a value obtained as each piece of information, in which case a node having a value exceeding the threshold is not selected as a reconstruction destination.

The redundancy processing unit 250 compares respective loads of reconstruction-executing nodes, the loads being calculated by the above methods, and ranks the nodes in the order of smallness of load (step S1570). The redundancy processing unit 250 then counts data blocks and class 2 redundant codes to be rebuilt.

When using a plurality of redundancy groups, the redundancy processing unit 250 acquires the number of reconstructions in all redundancy groups to be rebuilt (step S1580). A data block and/or a class 2 redundant code to be rebuilt, i.e., a rebuilding target, is allocated to reconstruction-executing nodes in order, with a node with a smaller load first, and reconstruction is executed at each node in a distributive manner (step S1590). When rebuilding targets are allocated, a rebuilding target involving a larger reconstruction process load may be allocated first to a node with a smaller node load.

### <not Transferring Rebuilt Class 2 Redundant Code to Substitute Node>

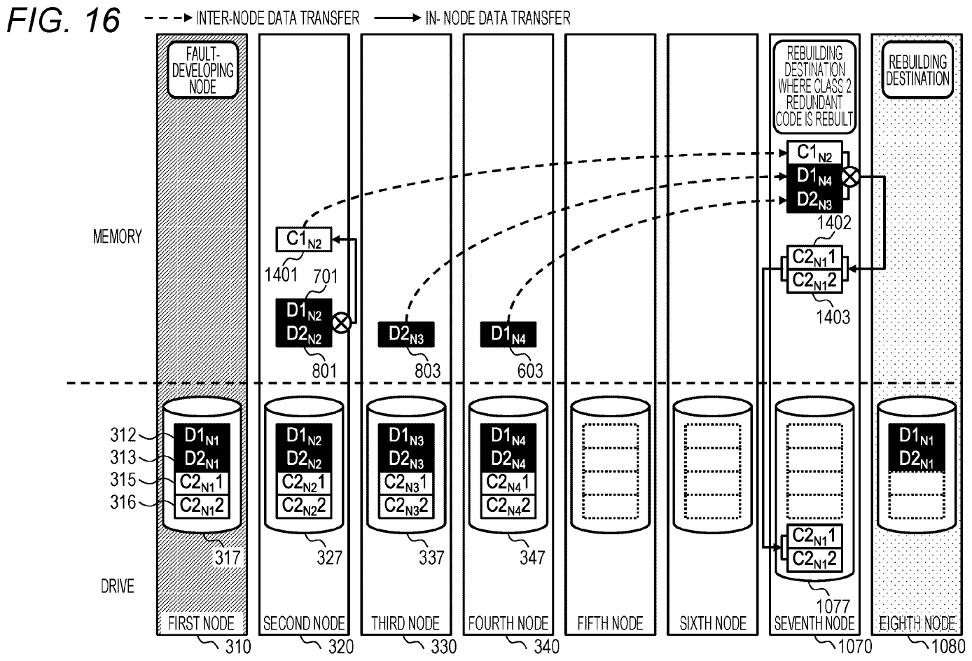

FIG. 16 depicts an example in which a class 2 redundant code reconstructed is not transferred to a substitute node. A class 2 redundant code has nothing to do with input/output to/from an application. Storing a class 2 redundant code reconstructed in a node different from the substitute node, therefore, does not affect input/output to/from an application.

For this reason, when reconstructing a class 2 redundant code, which is an example of a second redundant code stored in the storage device of one or more of the nodes 140, the redundancy processing unit 250 reconstructs the class 2 redundant code to be rebuilt, at a specific node different from the substitute node, and stores the class 2 redundant code in the storage device of the specific node. This allows a reduction in the number of data transferred to the substitute node. The node that executes rebuilding and stores the class 2 redundant code rebuilt may be selected based on a loaded state of the node, according to the method shown in FIG. 13.

In the example of FIG. 16, rebuilding is executed at the seventh node 1070 according to the following procedures.

Procedure (1): The redundancy processing unit 250, by the same procedures as shown in FIGS. 11 and 14, first reads the data blocks D1N2 701 and D2N2 801 from the drive 327 of the second node 320, transfers the data blocks D1N2 701 and D2N2 801 to the memory, and generates a class 1 redundant code C1N2 1401, using these data blocks D1N2 701 and D2N2 801.

Procedure (2): The redundancy processing unit 250 transfers the class 1 redundant code C1N2 1401 of the second node 320 to the seventh node 1070.

Procedure (3): The redundancy processing unit 250 transfers the data block D2N3 803 stored in the drive 337 of the third node 330, to the memory, and then transfers the data block D2N3 803 to the seventh node 1070.

Procedure (4): The redundancy processing unit 250 transfers the data block DIN4 603 stored in the drive 347 of the fourth node 340, to the memory, and then transfers the data block DIN4 603 to the seventh node 1070.

Procedure (5): In the seventh node 1070, the redundancy processing unit 250 reconstructs a class 2 redundant code C2N11 1402 and a class 2 redundant code C2N12 1403, from the class 1 redundant code C1N2 1401 transferred from the second node 320, the data block D2N3 803 transferred from the third node 330, and the data block D1N4 603 transferred from the fourth node 340.

Procedure (6): The redundancy processing unit 250 stores the class 2 redundant code C2N11 1402 and class 2 redundant code C2N12 1403 that have been reconstructed, in the drive 1077 of the seventh node 370.

In this case, by selecting a node that reconstructs a class 2 redundant code, as a node different from a node storing a data block used for reconstruction of the class 2 redundant code and/or a class 2 redundant code, even when the selected node develops a fault, the class 2 redundant code can be rebuilt. It is assumed in this case that the drive 1077 in which the class 2 redundant codes are stored has a data capacity large enough to store the class 2 redundant codes. Thus, the distributed storage system according to this embodiment is allowed to change a storage position of the class 2 redundant code.

The distributed storage system 130 according to this embodiment comprises a plurality of nodes each including the storage device that stores data and the controller 141 that makes data redundant, the data being stored in the storage device. The distributed storage system 130 puts each piece of data composed of a plurality of data blocks under distributive management in the nodes 140, receives an input/output request (I/O request) for data reading/writing from/to the host server 110 and writing data, and provides read data to the host server 110. The controller 141 divides data on a received writing request into a plurality of data blocks and writes the data blocks to the storage device, and generates a class 1 redundant code from the data blocks, the class 1 redundant code being an example of a first redundant code, and transmits the data blocks and the class 1 redundant code to a different node. A controller of the different node generates a class 2 redundant code, from a plurality of data blocks received from the nodes 140 and the first redundant code, and stores the class 2 redundant code in the storage device. The redundancy processing unit 250 rebuilds a data block and a second redundant code that are stored in the storage device of the node, at a different node, and a substitute node having rebuilt the data block stores the rebuilt data block in the storage device, and processes a reading request and a writing request from a host server. When rebuilding the data block and the second redundant code, one of the nodes reconstructs a data block involved in the rebuilding, based on the data block and the second redundant code that are stored in one of the nodes, generates a first redundant code, based on the data blocks stored in one of the nodes, reconstructs a second redundant code involved in the rebuilding, based on the first redundant code generated and on the data blocks stored in one of the nodes, and stores the data block and the second redundant code have been reconstructed and being involved in the rebuilding, in the storage device. A node that rebuilds the second redundant code is a specific node different from the substitute node in which the data block reconstructed is stored. Because of this configuration, when the substitute node storing the data block processes input/output from/to the host server after the rebuilding (during the rebuilding), a load on the substitute node can be reduced.

As described above, when rebuilding a data bock and a class 2 redundant node identical in content with a data bock and a class 2 redundant node that are stored in a fault-developing node, on a substitute node substituting for the fault-developing node in execution of the above-described method of executing two stages of redundancy processing, the distributed storage system of this embodiment reconstructs the class 2 redundant code at a specific node different from the substitute node, and then transfers the class 2 redundant code to the substitute node to store the redundant code therein. This allows a reduction in the number of data transferred to the substitute node. When a fault develops, therefore, a time required for rebuilding the data block and the class 2 redundant code of the data block can be reduced.

According to this embodiment, in execution of the erasure coding method for making data processed by the distributed storage system redundant, data inflow to a substitute node at rebuilding of a redundant code can be reduced as data locality is maintained. This allows a reduction in a time required for rebuilding. According to this embodiment, selecting a node with a low processing load and carrying out reconstruction allows efficient execution of the rebuilding process. It reduces an effect the rebuilding process has on host I/O performance as well.

In this embodiment, a node that reconstructs a data block involved in rebuilding, based on a data block and a class 2 redundant code, is a specific node different from a substitute node that stores the data block reconstructed.

In this embodiment, a class 2 redundant code reconstructed is stored in a substitute node.

In this embodiment, a node that stores a class 2 redundant code reconstructed is different from a substitute node that stores a data block reconstructed.

The distributed storage system 130 according to this embodiment includes the node information acquisition unit 260 that acquires node information indicating states of the nodes 140. When rebuilding a data block and a second redundant code stored in the storage device of one or more of the nodes 140, on a substitute node, the redundancy processing unit 250 selects a specific node that reconstructs the data block and the class 2 redundant code, based the states of the nodes 140 that are acquired by the node information acquisition unit 260. In this configuration, a preferable specific node that makes inter-node data transfer less is selected, based on the states of the nodes 140 that are acquired by the node information acquisition unit 260, and is used for reconstruction.

In this embodiment, the node information acquisition unit 260 acquires loaded states of a plurality of nodes, as states of a plurality of nodes. In this configuration, based on the loaded states of the nodes 140 acquired by the node information acquisition unit 260, the redundancy processing unit 250 more properly selects a specific node that reconstructs a data block and a class 2 redundant code, and reconstructs a data block and a second class 2 redundant code that are stored in the storage device of one or more of the nodes 140, on a substitute node.

In this embodiment, the redundancy processing unit 250 determines whether or not to execute reconstruction of a data block and a class 2 redundant code at a substitute node. When determining executing the reconstruction at the substitute node, the redundancy processing unit 250 transfers data necessary for the reconstruction, from respective storage devices of the nodes to the substitute node. When determining not executing the reconstruction at the substitute node, the redundancy processing unit 250 selects a specific node that executes the reconstruction, transfers data necessary for the reconstruction, from respective storage devices of the nodes to the specific node, executes the reconstruction at the specific node, and stores the class 2 redundant code reconstructed in the substitute node. In this configuration, even in the case where executing the reconstruction at the substitute node is not determined, the specific node that executes the reconstruction is selected to execute reconstruction of the data block and the class 2 redundant code.

In the distributed storage system 130 according to this embodiment, the redundancy processing unit 250 calculates respective node loads of storage nodes in operation or standby, from which a fault-developing node is excluded, using node information on a plurality of nodes, and selects a preferable specific node according to the node loads. In this configuration, a preferable specific node is selected according to the node loads of the storage nodes in operation or standby.

In this embodiment, the node information acquisition unit 260 acquires hardware operation information on each node, the hardware operation information being acquired at the point of start of rebuilding. In this configuration, a preferable specific node is selected, based on hardware operation information on each node, the hardware operation information being acquired at the point of start of rebuilding.

In this embodiment, the node information acquisition unit 260 acquires, as the above hardware operation information, any one of or any combination of these pieces of information: a CPU usage rate, a memory usage rate, a band usage rate of network hardware, such as a network interface card (NIC) each node has, a drive usage rate, a CPU temperature, an operating frequency, a supply voltage to a computer, and a fan rotating speed. In this configuration, a preferable specific node is selected according to these pieces of hardware operation information, and a data block and a class 2 redundant code are reconstructed at the specific node.

The present invention is not limited to the above embodiment, and includes various modifications and configurations equivalent thereto that are within the scope of the appended claims. For example, the above embodiment has been described in detail to facilitate understanding of the present invention, and the present invention is not necessarily limited to an embodiment including all constituent elements described above. Elements described in the embodiment as elements parallel to each other may be arranged such that at least one of the elements is connected in series to another element.

The present invention can be applied to a distributed storage system related to a technology of redundantly storing data.

What is claimed is:

1. A distributed storage system comprising a plurality of nodes each including: a storage device that stores data; and a controller that makes data redundant, the data being stored in the storage device, wherein the controller divides data on a received writing request into a plurality of data blocks and writes the data blocks to the storage device, and generates a first redundant code from the data blocks and transmits the data blocks and the first redundant code to a different node, wherein
a controller of the different node generates a second redundant code, from a plurality of data blocks received from the nodes and the first redundant code, and stores the second redundant code in the storage device, wherein
a data block and a second redundant code that are stored in the storage device of a node are rebuilt at a different node, and a substitute node having rebuilt the data block stores the data block reconstructed in the storage device and processes a reading request and a writing request from a host server,
wherein when rebuilding the data block and the second redundant code, one of the nodes reconstructs a data block involved in the rebuilding, based on the data block and the second redundant code that are stored in one of the nodes, generates a first redundant code, based on the data blocks stored in one of the nodes, reconstructs a second redundant code involved in the rebuilding, based on the first redundant code generated and on the data blocks stored in one of the nodes, and stores the data block and the second redundant code having been reconstructed and being involved in the rebuilding, in the storage device,
wherein a node that reconstructs the second redundant code is a specific node different from the substitute node in which the data block reconstructed is stored.

2. The distributed storage system according to claim 1, wherein a node that reconstructs a data block involved in the rebuilding, based on the data block and the second redundant code, is a specific node different from the substitute node that stores the data block reconstructed.

3. The distributed storage system according to claim 1, wherein the second redundant code reconstructed is stored in the substitute node.

4. The distributed storage system according to claim 1, wherein a node that stores the second redundant code reconstructed is different from the substitute node that stores the data block reconstructed.

5. The distributed storage system according to claim 1, wherein the controller acquires node information indicating a state of the node, and selects a specific node that reconstructs the data block and the second redundant code, based the acquired node information.

6. The distributed storage system according to claim 4, wherein the node information includes loaded states of the nodes.

7. The distributed storage system according to claim 3, wherein the controller determines whether or not to execute reconstruction of the data block and the second redundant code at the substitute node, wherein
when determining executing the reconstruction at the substitute node, the controller transfers data necessary for the reconstruction, from respective storage devices of nodes to the substitute node, and executes the reconstruction at the substitute node, wherein
when determining not executing the reconstruction at the substitute node, the controller selects a specific node that executes the reconstruction, transfers data necessary for the reconstruction, from respective storage devices of the nodes to the specific node, executes the reconstruction at the specific node, and stores the second redundant code reconstructed in the substitute node.

8. The distributed storage system according to claim 2, wherein the controller calculates respective node loads of storage nodes in operation or standby, from which a fault-developing node is excluded, using node information on the nodes, and selects the specific node according to the node loads.

9. The distributed storage system according to claim 6, wherein the controller uses the node information including hardware operation information on each node.

10. The distributed storage system according to claim 7, wherein a node information acquisition unit acquires, as the hardware operation information, any one of or any combination of these pieces of information: a central processing unit (CPU) usage rate, a memory usage rate, a band usage rate of network hardware each node has, a drive usage rate, a CPU temperature, an operating frequency, a supply voltage to a computer, and a fan rotating speed.

11. A data sharing method for a distributed storage system comprising a plurality of nodes each including: a storage device that stores data; and a controller that makes data redundant, the data being stored in the storage device,
wherein the data sharing method comprises:
causing the controller to divide data on a received writing request into a plurality of data blocks and write the data blocks to the storage device and to generate a first redundant code from the data blocks and transmit the data blocks and the first redundant code to a different node;
causing a controller of the different node to generate a second redundant code from a plurality of data blocks received from the nodes and store the second redundant code in the storage device; causing the controller to rebuild a data block and a second redundant code on a different node, the data block and the second redundant code being stored in the storage device of a node; causing a substitute node having rebuilt the data block to store the data block reconstructed in the storage device and process a reading request and a writing request from a host server;
when rebuilding the data block and the second redundant code, causing one of the nodes to reconstruct a data block involved in the rebuilding, based on the data block and the second redundant code that are stored in one of the nodes, to generate a first redundant code, based on the data blocks stored in one of the nodes, and to reconstruct a second redundant code involved in the rebuilding, based on the first redundant code generated and on the data block stored in one of the nodes, and to store the data block and the second redundant code having been reconstructed and being involved in the rebuilding, in the storage device; and
selecting a node that reconstructs the second redundant code, as a specific node different from the substitute node in which the data block reconstructed is stored.
